(19) United States
(12) Patent Application Publication
(10) Pub. No.: US 2016/0134591 A1
(43) Pub. Date: May 12, 2016

(54) VPN Implementation Processing Method and Device for Edge Device

(71) Applicant: ZTE CORPORATION, Guangdong (CN)

(72) Inventors: Ting LIAO, Shenzhen (CN); Bo WU, Shenzhen (CN); Xuehui DAI, Shenzen (CN)

(73) Assignee: ZTE Corporation, Guangdong (CN)

(21) Appl. No.: 14/896,024

(22) PCT Filed: May 15, 2014
(86) PCT No.: PCT/CN2014/077585

§ 371 Date: Dec. 4, 2015

(30) Foreign Application Priority Data
Jun. 5, 2013 (CN) 201310222321.1

(51) Int. Cl. H04L 29/06; H04L 12/721

(52) U.S. Cl. CPC H04L 63/0272; H04L 45/14

(57) ABSTRACT

The present disclosure discloses a Virtual Private Network (VPN) implementation processing method and device for an edge device. The method includes that: a VPN application request is acquired, wherein the VPN application request carries attribute configuration information about a VPN; VPN routing information is received from each edge device in the VPN; and VPN routing control information is sent to the edge devices, wherein the VPN routing control information is routing information obtained by performing centralized calculation and processing on the attribute configuration information and the VPN routing information. Adopting the above solution provided in the present disclosure solves the technical problems in the prior art that there are more complex configuration and table item contents in an automatic control solution for the VPN, etc., thereby being able to automatically control simpler configuration issuing, more intensive table item management and table item issuing under a uniform control platform, so that the configuration and table item capacity of the existing device are reduced.

### TECHNICAL FIELD

The present disclosure relates to the field of communications, and in particular to a Virtual Private Network (VPN) implementation processing method and device for an edge device.

### BACKGROUND

At present, a new Interface to the Routing System (I2RS) work group which is established by the Internet Engineering Task Force (IETF) standard organization focuses on researching an interface to the routing system, in order to provide for the existing routing system a compatible interface which can directly read and write policy configurations of a router and a routing information table of a Routing Information Base (RIB). A general I2RS model described in the existing I2RS related personal draft is shown in FIG. 1; contents in dotted boxes of the lower part of the diagram represent internal implementing components of a router. An I2RS Agent is an added component of the router for supporting the I2RS, so that an I2RS Client can acquire, through the I2RS Agent, related information about configuration management and topology route of the router, and the I2RS Client can issue configurations, routing entry specification and other information to the router through the I2RS Agent. The major difference between the work group and the existing Open Network Foundation (ONF) of the standard organization related to implementation of the Software Defined Network (SDN) is that the I2RS does not directly issue a forwarding table in a Forwarding Information Base (FIB) of a data plane, but influences the final forwarding table by influencing information of a protocol routing table, thus being able to be compatible with the existing router better.

The VPN is a logical network isolation technology in a physical network; the Multi-Protocol Label Switching (MPLS) VPN of the current router is generally implemented by providing Layer 2 VPN (L2VPN) services and Layer 3 VPN (L3VPN) services for customers through providers; these services are usually implemented through the MPLS and a Border Gateway Protocol (BGP), specifically including that: the provider provides attribute information related to a VPN service to the customer, and the customer can perform a Customer Edge (CE) configuration according to these information or enables the provider to configure on the CE by authorizing management to the provider; the provider takes charge of opening the connectivity of the provider network which is provided for the customer and needed by the VPN service, including VPN related connection and configuration on a Provider Edge (PE) device and a Provider (P) device in the network. Because the manual configuration is featured by inflexible configuration and large time delay, an automatic configuration mode is expected. The current automatic configuration is also implemented by a background remote issuing way based on the existing configuration. Besides, if a PE table item entry reducing or policy function on the existing router is wanted, it is needed to provide a centralized Route Reflector (RR) function in the BGP network and then continue to perform the complex policy configuration on the reflector. However, if a protection function of the VPN is wanted, the dual-protection can be implemented only by enabling corresponding protection functions on both a local end and a remote end.

Aiming at the above problems in related technologies, an effective solution has not been presented.

### SUMMARY

Aiming at the technical solutions in the prior art that that there are more complex configuration and table item contents in an automatic control solution for the VPN, etc., the present disclosure provides a VPN implementation processing method and device for an edge device for at least solving the above problems.

According to one aspect of the present disclosure, a VPN implementation processing method for an edge device is provided, which includes that: a VPN application request is acquired, wherein the VPN application request carries attribute configuration information about a VPN; VPN routing information is received from each edge device in the VPN; and VPN routing control information is sent to the each edge device, wherein the VPN routing control information is routing information obtained by performing centralized calculation and processing on the attribute configuration information and the VPN routing information.

The VPN routing information or the routing control information includes at least one of the following: a VPN Table Identity (ID) and table item entries, wherein the VPN Table ID is used for locally identifying a table item number generated according to the VPN routing information.

The table item entries include at least one of the following: a key value of table item, a next hop, an outgoing interface, a protocol type, a VPN ID, a VPN forwarding plane ID, a master/slave ID, a load sharing ID and effective time.

The table item entries in the VPN routing information and the table item entries in the routing control information are partly same or totally different.

The key value of table item includes: a destination address of a data message.

The next hop is a direct next hop ID of the edge device or a peer ID of a multi-hop neighbour.

The outgoing interface from the edge device to a Network Management System (NMS) is a local VPN binding interface or a local device ID of the edge device, and the outgoing interface from the NMS to the edge device is a mapping ID of a remote edge device.

The mapping ID includes at least one of the following: the ID of the remote edge device; and a logical outgoing interface ID or a physical outgoing interface ID of the edge device to the remote edge device.

The protocol type is used for identifying an I2RS protocol and/or other routing protocols except the I2RS protocol.

The VPN forwarding plane ID is used for identifying an encapsulated or de-encapsulated data plane message.

The master/slave ID is used for respectively identifying multiple next hops with the same key value of table item as master and slave.

The VPN ID is in one-to-one correspondence with the VPN on a control plane.

The load sharing ID is used for identifying the multiple next hops with the same key value of table item.

The effective time is realized by at least one of the following ways: taking effect and timing according to the time to live which is configured by the edge device or defaulted; synchronously taking effect on the edge device according to an effective time period which is issued by the NMS; sending or cancelling sending the routing information on the NMS according to the local effective time.

The attribute configuration information includes at least one of the following: the VPN ID, information about setting of a Routing Target (RT) value, information about the ID of a PE site requiring opening the VPN, information about the type of the routing protocol needing to be enabled, priority configuration information and policy information.

The policy information includes at least one of the following: a filtering or changing policy based on table item entry contents, a time presetting policy, a master/slave policy and a load sharing policy.

The edge devices include at least one of the following: a PE and a CE.

According to another aspect of the present disclosure, a VPN implementation processing method for an edge device is provided, which includes that: the VPN routing information is sent to the NMS; the VPN routing control information is received from the NMS, wherein the VPN routing control information is VPN routing information obtained by performing centralized calculation and processing on the VPN routing information and the attribute configuration information about the VPN which is obtained by the NMS from the VPN application request; and the edge device is configured according to the VPN routing control information.

The VPN routing information or the routing control information includes at least one of the following:

the VPN Table ID and the table item entries, wherein the VPN Table ID is used for locally identifying the table item number generated according to the VPN routing information.

The table item entries include at least one of the following: the key value of table item, the next hop, the outgoing interface, the protocol type, the VPN ID, the VPN forwarding plane ID, the master/slave ID, the load sharing ID and the effective time.

The key value of table item includes: the destination address of the data message; and/or the next hop is the direct next hop ID of the edge device or the peer ID of the multi-hop neighbour; and/or the outgoing interface from the edge device to the NMS is the local VPN binding interface or the local device ID of the edge device, and the outgoing interface from the NMS to the edge device is the mapping ID of the remote edge device; and/or the protocol type is used for identifying the I2RS protocol and/or other routing protocols except the I2RS protocol; and/or the VPN forwarding plane ID is used for identifying the encapsulated or de-encapsulated data plane message; and/or the master/slave ID is used for respectively identifying the multiple next hops with the same key value of table item as master and slave; and/or the VPN ID is in one-to-one correspondence with the VPN on the control plane; and/or the load sharing ID is used for identifying the multiple next hops with the same key value of table item.

The table item entries in the VPN routing information and the table item entries in the routing control information are partly same or totally different.

The mapping ID includes at least one of the following: the ID of the remote edge device; the logical outgoing interface ID or the physical outgoing interface ID of the edge device to the remote edge device.

The effective time is realized by at least one of the following ways: taking effect and timing according to the time to live which is configured by the edge device or defaulted; synchronously taking effect on the edge device according to the effective time period which is issued by the NMS; sending or cancelling sending the routing information on the NMS according to the local effective time.

The attribute configuration information includes at least one of the following: the VPN ID, the information about setting of the RT value, the information about the ID of the PE site requiring opening the VPN, the information about the type of the routing protocol needing to be enabled, the priority configuration information and the policy information.

The policy information includes at least one of the following: the filtering or changing policy based on table item entry contents, the time presetting policy, the master/slave policy and the load sharing policy.

According to another aspect of the present disclosure, a VPN implementation processing device for an edge device is provided, which includes: an acquiring component, which is configured to acquire the VPN application request, wherein the VPN application request carries the attribute configuration information about the VPN; a receiving component, which is configured to receive the VPN routing information from each edge device in the VPN; and a sending component, which is configured to send the VPN routing control information to the edge devices, wherein the VPN routing control information is routing information obtained by performing centralized calculation and processing on the attribute configuration information and the VPN routing information.

The receiving component and the sending component are respectively configured to receive the VPN routing information and send the VPN routing control information when the VPN routing information and/or the VPN routing control information include/includes at least one piece of the following: the VPN Table ID and the table item entries, wherein the VPN Table ID is used for locally identifying the table item number generated according to the VPN routing information.

The receiving component and the sending component are respectively configured to receive the VPN routing information and send the VPN routing control information when the table item entries include at least one of the following: the key value of table item, the next hop, the outgoing interface, the protocol type, the VPN ID, the VPN forwarding plane ID, the master/slave ID, the load sharing ID and the effective time;

wherein the key value of table item includes: the destination address of the data message; and/or the next hop is the direct-connection next hop ID of the edge device or the peer ID of the multi-hop neighbour; and/or the outgoing interface from the edge device to the NMS is the local VPN binding interface or the local device ID of the edge device, and the outgoing interface from the NMS to the edge device is the mapping ID of the remote edge device; and/or the protocol type is used for identifying the I2RS protocol and/or other routing protocols except the I2RS protocol; and/or the VPN forwarding plane ID is used for identifying the encapsulated or de-encapsulated data plane message; and/or the master/slave ID is used for respectively identifying the multiple next hops with the same key value of table item as master and slave; and/or the VPN ID is in one-to-one correspondence with the VPN on the control plane; and/or the load sharing ID is used for identifying the multiple next hops with the same key value of table item.

According to another aspect of the present disclosure, a VPN implementation processing device for an edge device is provided, which includes: a sending component, which is configured to send the VPN routing information to the network management system; a receiving component, which is configured to receive the VPN routing control information from the NMS, wherein the VPN routing control information is routing information obtained by performing centralized calculation and processing on the VPN routing information and the attribute configuration information about the VPN which is obtained by the NMS from the VPN application request; and a configuring component, which is configured to configure the edge device according to the VPN routing control information.

The receiving component and the sending component are respectively configured to receive the VPN routing control information and send the VPN routing information when the VPN routing control information and/or the VPN routing information include/includes one of the following: the VPN Table Identity ID and the table item entries, wherein the VPN Table ID is used for locally identifying the table item number generated according to the VPN routing information.

The receiving component and the sending component are respectively configured to receive the VPN routing control information and send the VPN routing information when the table item entries include at least one of the following: the key value of table item, the next hop, the outgoing interface, the protocol type, the VPN ID, the VPN forwarding plane ID, the master/slave ID, the load sharing ID and the effective time;

wherein the key value of table item includes: the destination address of the data message; and/or the next hop is the direct next hop ID of the edge device or the peer ID of the multi-hop neighbour; and/or the outgoing interface from the edge device to the NMS is the local VPN binding interface or the local device ID of the edge device, and the outgoing interface from the NMS to the edge device is the mapping ID of the remote edge device; and/or the protocol type is used for identifying the I2RS protocol and/or other routing protocols except the I2RS protocol; and/or the VPN forwarding plane ID is used for identifying the encapsulated or de-encapsulated data plane message; and/or the master/slave ID is used for respectively identifying the multiple next hops with the same key value of table item as master and slave; and/or the VPN ID is in one-to-one correspondence with the VPN on the control plane; and/or the load sharing ID is used for identifying the multiple next hops with the same key value of table item.

In the present disclosure, centralized calculation and processing is performed on the VPN application request and the VPN routing information of the edge device to issue the obtained configuration and routing control information, the technical problems in the prior art that there are more complex configuration and table item contents in an automatic control solution for the VPN, etc. are solved, thereby being able to automatically control simpler configuration issuing, more intensive table item management and table item issuing under a uniform control platform, so that the configuration and table item capacity of the existing device are reduced.

### BRIEF DESCRIPTION OF THE DRAWINGS

The accompanying drawings described here are used for providing a deeper understanding of the present disclosure, and constitute a part of the application; schematic embodiments of the present disclosure and description thereof are used for illustrating the present disclosure and not intended to form an improper limit to the present disclosure. In the accompanying drawings:

FIG. 1 is a diagram of an I2RS model according to related art;

FIG. 2 is a flowchart of a VPN implementation processing method for an edge device according to an embodiment of the present disclosure;

FIG. 3 is a structural diagram of a VPN implementation processing device for an edge device according to an embodiment of the present disclosure;

FIG. 4 is another flowchart of a VPN implementation processing method for an edge device according to an embodiment of the present disclosure;

FIG. 5 is another structural diagram of a VPN implementation processing device for an edge device according to an embodiment of the present disclosure;

FIG. 6 is a topological diagram of an I2RS network according to a preferred embodiment of the present disclosure;

FIG. 7 is another topological diagram of the I2RS network according to a preferred embodiment of the present disclosure; and

FIG. 8 is a flowchart of a method for implementing automatic control of a VPN according to a preferred embodiment of the present disclosure.

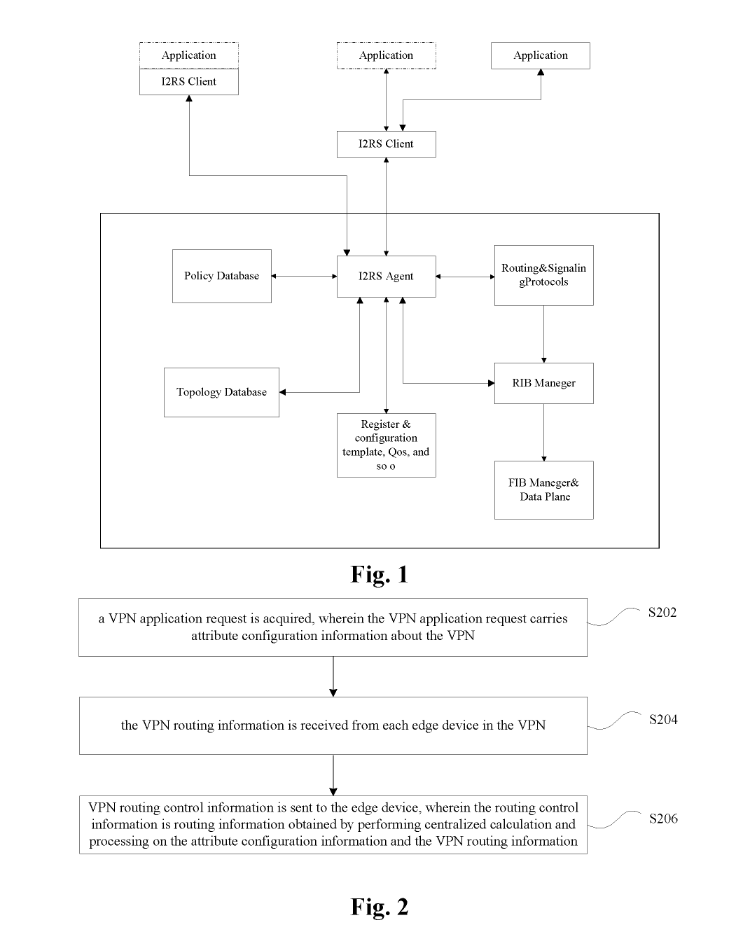

### DETAILED DESCRIPTION OF THE EMBODIMENTS

The present disclosure is elaborated below with reference to the accompanying drawings and embodiments. Note that, embodiments and features in embodiments in the application can be combined with each other on condition of not conflicting.

FIG. 2 is a flowchart of a VPN implementation processing method for an edge device according to an embodiment of the present disclosure. The method in the present disclosure may be, but is not limited to being, applied to the NMS. As shown in FIG. 2, the method includes the following blocks.

In block 202, a VPN application request is acquired, wherein the VPN application request carries attribute configuration information about the VPN. In the process of specific implementation, there are many ways of acquiring the VPN application request, for example, it may be implemented by receiving the VPN application request from a device on the side of the VPN, or by receiving the VPN application request from an upper service.

In block 204, the VPN routing information is received from each edge device in the VPN. The VPN routing information generally includes, but is not limited to, routing information from a device on the side of a local CE, wherein the routing information may include: a prefix, a mask, a next hop, an outgoing interface, a routing protocol type, a priority, a metric, a master/slave ID and a load sharing ID.

In block 206, VPN routing control information is sent to the edge device, wherein the routing control information is routing information obtained by performing centralized calculation and processing on the attribute configuration information and the VPN routing information.

Note that, the performing sequence between block 202 and block 204 is not limited to this; for example, it is feasible to first perform block 204, and then perform block 202.

Through the above processing blocks, because of performing centralized calculation and processing on the VPN application request and VPN customer information of the edge device, namely uniform control, simpler configuration issuing, more intensive table item management and table item issuing may be automatically controlled under the uniform control platform, so that the configuration and table item capacity of the existing device are reduced.

In the present embodiment, before receiving the VPN customer information (mainly appearing as the routing information) from the edge device, it is also feasible to determine the edge device according to the VPN application request and local network topology information. After determining the edge device according to the VPN application request and the local network topology information, VPN configuration information is generated according to the above specified information and topology information collected by the NMS; the VPN configuration information is issued to the edge device, wherein the edge device generates the VPN customer information according to the VPN configuration information.

In the present embodiment, the VPN customer information includes at least one piece of the following: a VPN Table ID and a plurality of table item entries, wherein the VPN Table ID is used for locally identifying a table item number generated according to the VPN customer information, so that an I2RS Client directly reads and writes the VPN related table items.

The table item entries include at least one of the following: a key value of table item, a next hop, an outgoing interface, a protocol type, a VPN ID, a VPN forwarding plane ID, a master/slave ID, a load sharing ID and effective time.

It can be seen from the above embodiment that the VPN routing control information is the VPN routing information after calculation and processing performed by the NMS through the policy, which can appear as change between their table item entries; that is, the table item entries in the VPN routing information and the table item entries in the routing control information are partly same or totally different.

The key value of table item includes: a destination address of a data message. The destination address is a Media Access Control (MAC) address in the L2VPN, and is an Internet Protocol (IP) address in the L3VPN. The key value of table item is not limited to the destination address, but can also be an effective field which is parsed from the data message according to the need, for example, a source address and a port number can also be supported.

The next hop is the direct next hop ID of the edge device or the peer ID of the multi-hop neighbour. The peer ID may be an ID of the remote edge device which establishes a neighbour relation with the edge device and publishes the key value of table item. The peer ID is generally the IP address of loopback identifying the remote edge device or the IP address of an interface for establishing the link.

The outgoing interface from the edge device to the NMS is the local VPN binding interface or the local device ID of the edge device, and the outgoing interface from the NMS to the edge device is the mapping ID of the remote edge device. The mapping ID includes at least one of the following: an ID of the remote edge device; a logical outgoing interface ID or a physical outgoing interface ID of the edge device to the remote edge device. Specifically, the mapping ID may be a local channel ID, wherein the local channel ID indicates an end-to-end connection from local to the remote edge device, which may be a Generic Routing Encapsulation (GRE) channel ID, a Resource Reserve Protocol (RSVP) Traffic Engineering (TE) channel ID, and a Label Switched Paths (LSP) channel ID.

The protocol type is used for identifying the I2RS protocol and/or other routing protocols except the I2RS protocol. The VPN forwarding plane ID is used for identifying the encapsulated or de-encapsulated data plane message.

The master/slave ID is used for respectively identifying the multiple next hops with the same key value of table item as master and slave, so that the multiple next hops respectively carry master ID and slave ID to issue.

The VPN ID is in one-to-one correspondence with the VPN on the control plane, namely the VPN ID is used for uniquely identifying a VPN on the control plane globally, which is implemented by, but not limited to, an RT mode.

The load sharing ID is used for identifying the multiple next hops with the same key value of table item, so that the multiple next hops with the same key value of table item may take effect simultaneously.

The effective time is realized by at least one of the following method:

taking effect and timing according to time to live which is configured by the edge device or defaulted, namely taking effect and timing according to the time to live which is issued by the table item; for example, a PE's own timer is used for timing after the table item is generated (e.g. counting down from 300 s based on saving time), if an update is not received when the timer expires, then it is considered that the table item is aged;

synchronously taking effect on the edge device according to the effective time period which is issued by the NMS; the NMS issues a time period, wherein the table item takes effect in the time period (e.g. 8:00-8:30), then the entry is placed in an RIB table during the synchronous effective time of the edge device;

sending or cancelling sending the routing information on the NMS according the local effective time; wherein when the effective time of the NMS is over, the I2RS Client of the NMS issues information of cancelling a specified table item, that is, timing management is maintained on the I2RS Client, it is only needed to issue the entry during the effective time, and cancel the entry during the time of not taking effect.

In the present embodiment, the application request includes the request of opening the upper service and/or policy which includes a policy request of the VPN service, flow matching filtering, load sharing, and time value.

The attribute configuration information includes at least one piece of the following: a VPN ID, information about setting of the RT value, information about the ID of the PE site requiring opening the VPN, the information about the type of the routing protocol needing to be enabled, the priority configuration information and the policy information. The policy information includes at least one piece of the following: the filtering or changing policy based on the table item entry contents, the time presetting policy, the master/slave policy and the load sharing policy.

The forwarding devices include at least one of the following: a PE and a CE.

The VPN customer information includes at least one piece of the following: information of the VPN ID, the information about setting of the RT value, information about location of the CE in the VPN, configuration information about CE access and a policy request.

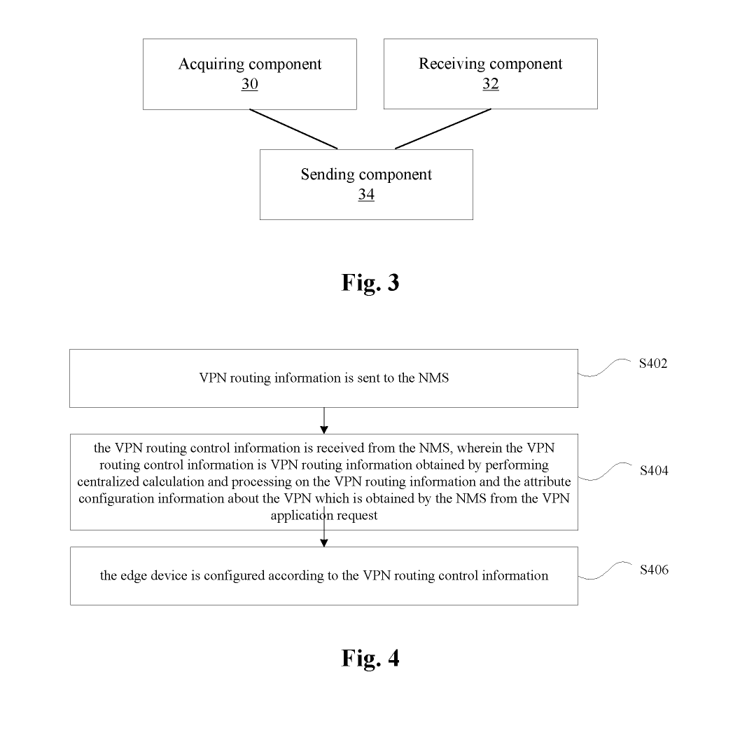

FIG. 3 is a structural diagram of a VPN implementation processing device for an edge device according to an embodiment of the present disclosure. The device may be, but is not limited to being, applied to the NMS; as shown in FIG. 3, the device includes:

an acquiring component 30, which is connected to the sending component 34 and configured to acquire a VPN application request, wherein the VPN application request carriers attribute configuration information about the VPN;

a receiving component 32, which is connected to the sending component 34 and configured to receive the VPN routing information from each edge device in the VPN; and

a sending component 34, which is configured to send the VPN routing control information to the edge devices, wherein the VPN routing control information is routing information obtained by performing centralized calculation and processing on the attribute configuration information and the VPN routing information;

through functions implemented by the above components, simpler configuration issuing, more intensive table item management and table item issuing may also be automatically controlled under the uniform control platform, so that the configuration and table item capacity of the existing device are reduced.

In one embodiment, the receiving component 32 and the sending component 34 are respectively configured to receive the VPN routing information and send the VPN routing control information when the VPN routing information and/or the VPN routing control information include/includes at least one piece of the following: a VPN Table ID and a plurality of table item entries, wherein the VPN Table ID is used for locally identifying a table item number generated according to the VPN customer information.

The receiving component and the sending component are respectively configured to receive the VPN routing information and send the VPN routing control information when the table item entries include at least one piece of the following:

a key value of table item, a next hop, an outgoing interface, a protocol type, a VPN ID, a VPN forwarding plane ID, a master/slave ID, a load sharing ID and effective time;

the key value of table item includes: a destination address of a data message; and/or the next hop is a direct next hop ID of the edge device or a peer ID of the multi-hop neighbour; and/or the outgoing interface from the edge device to the NMS is the local VPN binding interface or the local device ID of the edge device, and the outgoing interface from the NMS to the edge device is the mapping ID of the remote edge device; and/or the protocol type is used for identifying the I2RS protocol and/or other routing protocols except the I2RS protocol; and/or the VPN forwarding plane ID is used for identifying a encapsulated or de-encapsulated data plane message; and/or the master/slave ID is used for respectively identifying the multiple next hops with the same key value of table item as master and slave; and/or the VPN ID is in one-to-one correspondence with the VPN on the control plane; and/or the load sharing ID is used for identifying the multiple next hops with the same key value of table item.

Note that, the components may be implemented by corresponding processors; for example, the components may separately correspond to a processor to be implemented; of course, part or all of them may be integrated in a processor to be implemented; however, the above combination does not form a limit.

In the present embodiment, a VPN implementation processing method for an edge device is provided. As shown in FIG. 4, the method includes the following blocks.

In block 402, VPN routing information is sent to the NMS.

In block 404, the VPN routing control information is received from the NMS, wherein the VPN routing control information is VPN routing information obtained by performing centralized calculation and processing on the VPN routing information and the attribute configuration information about the VPN which is obtained by the NMS from the VPN application request.

In block 406, the edge device is configured according to the VPN routing control information.

The VPN routing information or the routing control information includes at least one piece of the following: a VPN Table ID and table item entries, wherein the VPN Table ID is used for locally identifying a table item number generated by the VPN routing information.

The table item entries include at least one of the following: a key value of table item, a next hop, an outgoing interface, a protocol type, a VPN ID, a VPN forwarding plane ID, a master/slave ID, a load sharing ID and effective time, wherein the key value of table item includes: a destination address of a data message; and/or the next hop is a direct next hop ID of the edge device or a peer ID of the multi-hop neighbour; and/or the outgoing interface from the edge device to the NMS is a local VPN binding interface or a local device ID of the edge device, and the outgoing interface from the NMS sends to the edge device is a mapping ID from the remote edge device; and/or the protocol type is used for identifying the I2RS protocol and/or other routing protocols except the I2RS protocol; and/or the VPN forwarding plane ID is used for identifying the encapsulated or de-encapsulated data plane message; and/or the master/slave ID is used for respectively identifying the multiple next hops carried by the same key value of table item as master and slave; and/or the VPN ID is in one-to-one correspondence with the VPN on the control plane; and/or the load sharing ID is used for identifying the multiple next hops with the same key value of table item.

The table item entries in the VPN routing information and the table item entries in the routing control information are partly same or totally different. The mapping ID includes at least one of the following: an ID of the remote edge device; ID of the logical outgoing interface or the physical outgoing interface from the edge device to the remote edge device.

The effective time is realized by at least one of the following ways: taking effect and timing according to the time to live which is configured by the edge device or defaulted; synchronously taking effect on the edge device according to the effective time period which is issued by the NMS; performing effective sending or cancelling sending the routing information on the NMS according the local effective time.

The attribute configuration information includes at least one piece of the following: the VPN ID, information about setting of the RT value, information about the ID of the PE site requiring opening the VPN, information about the type of the routing protocol needing to be enabled, priority configuration information and policy information.

The policy information includes at least one piece of the following: a filtering or changing policy based on table item entry contents, a time presetting policy, a master/slave policy and a load sharing policy.

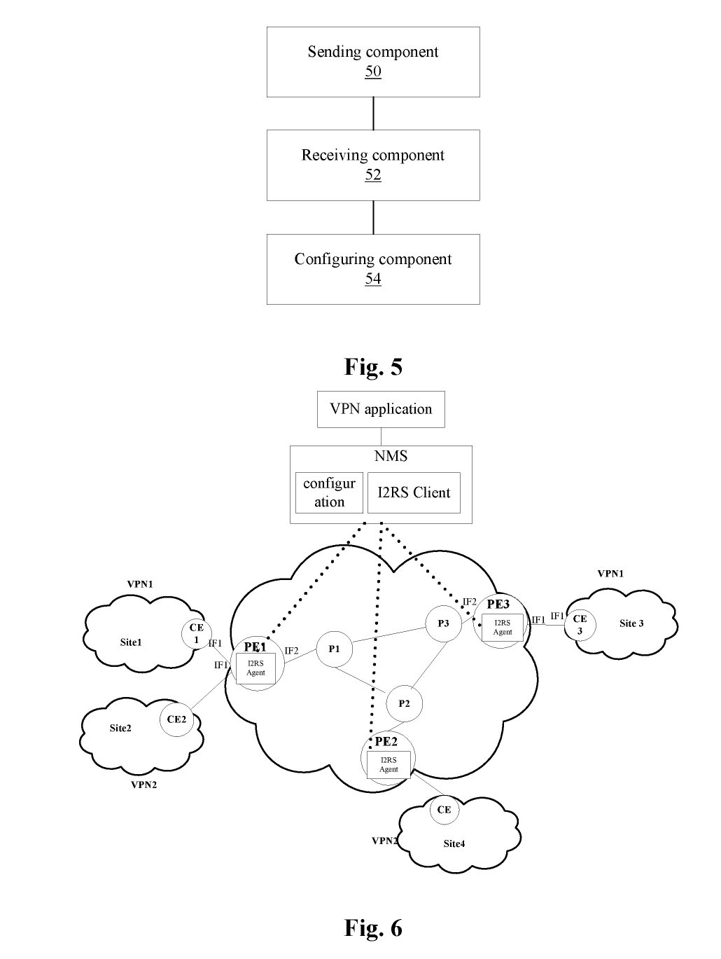

For implementing the above method, the present embodiment also provides a VPN implementation processing device for an edge device; as shown in FIG. 5, the device includes:

a sending component 50, which is connected to the receiving component 52 and configured to send VPN routing information to an NMS;

a receiving component 52, which is connected to the configuring component 54 and configured to receive VPN routing control information from the NMS, wherein the VPN routing control information is routing information obtained by performing centralized calculation and processing on the VPN routing information and the attribute configuration information about the VPN which is obtained by the NMS from the VPN application request; and

a configuring component 54, which is configured to configure the edge device according to the VPN routing control information.

In the present embodiment, the sending component 50 and the receiving component 52 are respectively configured to send the VPN routing information and receive the routing control information when the VPN routing information and/or the routing control information include/includes at least one piece of the following: a VPN Table ID and a plurality of table item entries, wherein the VPN Table ID is used for locally identifying a table item number generated by the VPN routing information.

The receiving component 52 and the sending component 50 are respectively configured to receive the VPN routing information and send the VPN routing control information when the table item entries include at least one piece of the following:

a key value of table item, a next hop, an outgoing interface, a protocol type, a VPN ID, a VPN forwarding plane ID, a master/slave ID, a load sharing ID and effective time.

The key value of table item includes: a destination address of a data message; and/or the next hop is a direct next hop ID of the edge device or the peer ID of the multi-hop neighbour; and/or the outgoing interface from the edge device sends to the NMS is the local VPN binding interface or the local device ID of the edge device, and the outgoing interface from the NMS to the edge device is the mapping ID of the remote edge device; and/or the protocol type is used for identifying the I2RS protocol and/or other routing protocols except the I2RS protocol; and/or the VPN forwarding plane ID is used for identifying the encapsulated or de-encapsulated data plane message; and/or the master/slave ID is used for respectively identifying the multiple next hops with the same key value of table item as master and slave; and/or the VPN ID is in one-to-one correspondence with the VPN on the control plane; and/or the load sharing ID is used for identifying the multiple next hops with the same key value of table item.

For understanding the above embodiments better, a detailed elaboration is given below in combination with the preferred embodiments and related accompanying drawings.

### Embodiment 1

A method that an IP/MPLS network dynamically establishes and manages a VPN service through the NMS is provided, in which the NMS receives a VPN service application request and uniformly controls the table items of services of the PE through the interface. The method includes that:

after receiving the VPN routing information sent from the PE, the NMS performs centralized calculation and processing on the received information in combination with the application request to generate processed information, and issues the processed information to the forwarding device.

The VPN routing information includes a VPN Table ID and a plurality of table item entries; the contents in the table item entries include, but are not limited to: part or all of a key value of table item, the next hop, an outgoing interface, a VPN ID, a VPN forwarding plane ID, a protocol type, a master/slave ID, a load sharing ID and effective time.

The NMS includes a forwarding device information interaction component, an application interaction component, a calculation component and a storage component. The forwarding device information interaction component is configured to collect information from the forwarding device or to issue information to the forwarding device. The forwarding device information interaction component may be an I2RS Client component.

The forwarding device includes an NMS interaction component which may be an I2RS Agent component. The forwarding device may be a PE or a CE.

The application request is a request for opening the upper service and policy, and the request for opening the upper service and policy is a policy request for requesting a VPN service, flow matching filtering, load sharing, and time value.

The centralized calculation and processing include performing, in the calculation component and the storage component, centralized calculation and processing according to the information collected by the forwarding device and the application request. The centralized calculation and processing further include storing the processed information.

The VPN forwarding plane ID is used for encapsulating and de-encapsulating the data message, The VPN forwarding plane ID appears in, but is not limited to, the form of label.

The protocol type is used for identifying the I2RS protocol and/or other routing protocols except the I2RS protocol, e.g. the BGP, etc.

The master/slave ID is mainly used for issuing the optimal route ID and the suboptimal route ID simultaneously for protection.

The load sharing ID is used for identifying the multiple next hops carried by the same key value of table item, so that the multiple next hops of the same key value of table item can take effect simultaneously to make multiple paths form load sharing.

In the present embodiment, a communication device used for the IP/MPLS network is also provided, which includes the NMS interaction component. The NMS interaction component establishes a VPN customer connection by sending the VPN routing information received locally to the NMS and receiving the VPN routing information of a remote end from the NMS. The VPN routing information is composed of a VPN Table ID and a plurality of table item entries; the contents in the table item entries include, but are not limited to: part or all of a key value of table item, a next hop, an outgoing interface, a VPN ID, a VPN forwarding plane ID, a protocol type, a master/slave ID, a load sharing ID and effective time.

The communication device creates the table item for maintaining the VPN routing information.

The creation of the table item includes generating the locally unique VPN Table ID for identifying the unique VPN ID table item; the table item entries are composed of part or all of the table item contents; maintenance of the table item may be either locally updated in real time or controlled by the Client through the Agent.

The present embodiment also provides an NMS, which includes: a forwarding device information interaction component, an application interaction component, a calculation component and a storage component. The application interaction component is mainly configured to receive the application request of the upper service, the forwarding device information interaction component is configured to interact with the forwarding device, and it may be the I2RS Client component. The NMS generates new information by performing centralized calculation on the application request information and the information obtained by the forwarding device information interaction component, and issues the new information to the forwarding device. The new information is mainly composed of the VPN Table ID and the table item entries; the contents in the table item entries include, but are not limited to: part or all of the key value of table item, the next hop, the outgoing interface, the VPN ID, the VPN forwarding plane ID, the master/slave ID, the load sharing ID and the effective time.

### Embodiment 2

### Automatic Control and Related Table Item Issuing for the L3VPN

As shown in FIG. 6, both the site 1 and the site 3 belong to the VPN1, and both the site 2 and the site 4 belong to the same VPN2; when a VPN access is performed on each PE, in the prior art, it is needed to manually configure information about the VPN1 and the VPN2 on each PE; after the configuration is completed, the route of VPN1 and the route of VPN2 are maintained through the different table items on each PE, and the RT values carrying matching attributes are imported in or exported from corresponding forwarding tables to implement isolation of the VPN. Such isolation will result in publishing all local effective Virtual Routing & Forwarding Instances (VRF) in a VPN message carried by the BGP on the PE1, PE2 and PE3, for example, the VPN1 message on the PE1 will be received on the PE2, but this message is totally ineffective for the PE2 and takes the time of bandwidth transmission and filtering protocol messages.

With reference to the prior art in which the CE1 and CE3 open connectivity configuration of the VPN1, configuration references are as follows.

1. The addresses of the loopback 1 and the interface IF1 are configured on the CE1, an External Border Gateway Protocol (EBGP) neighbour relation with the PE1 is established, and the loopback is informed in the BGP.

2. vrf vpn1 is configured on the PE1; the interface IF1 is bound in the vrf vpn1 and configured with an address; the addresses of the loopback 1 and the interface IF2 are configured; Open Shortest Path First (OSPF) is configured; a network segment which the address of the interface IF2 is in is informed; a Multi-Protocol Border Gateway Protocol (MPBGP) neighbour relation with the PE3 is established; an EBGP neighbour relation with the CE1 is established; the interface IF2 initiates a Label Distribution Protocol (LDP); the loopback1 is specified as router-id of the LDP. The VPN related configurations include that: the VRF configuration including ip vrf vpn1, a Route Distinguisher (RD) (used for uniquely identifying the VPN), the RT (used for identifying the ID carried by import and export router); the interface is bound with the VRF (indicating that the interface is connected with the CE, and the route learned by the interface is a private network route), and establishment of MPBGP neighbour (used for distributing labels for local private network routes after it is judged that the neighbour is established, and searching a outer label by using an ID of a neighbor with which a link is established).

3. The address of the interface for creating a link is configured on the P device; the OSPF is configured for informing the network segment where the address of the interface is; the interface initiates the LDP, configures the loopback1 and specifies the loopback1 as the router-id of the LDP.

4. The vrf vpn1 is configured on the PE3; the interface IF1 is bound in the vrf vpn1 and configured with an address; the addresses of the loopback1 and the interface IF2 are configured; the OSPF is configured; the network segment which the address of a public network is in is informed; the MPGBG neighbour relation with the PE1 is established; the OSPF neighbour relation with the CE3 is established; and the interface IF2 initiates the LDP.

5. The addresses of the loopback1 and the interface are configured on the CE3; the OSPF is configured; and the network segment where the address of the interface is and the address of the loopback are informed.

In the framework of the I2RS, as shown in FIG. 6, the customer may make requirements according to application layers provided in the I2RS model; for example, the customer of the VPN1 makes, through the application layer, a requirement to the NMS of opening intercommunication between the site 1 and the site 3 through the VPN; the NMS knows the PE connected to the site 1 and the site 3 are the PE1 and the PE3 through topology collection, then the NMS returns the interface configuration information related to the PE1 and the PE3 to the customer (certainly, the information may also be synchronized to the NMS by the application layer according to the configuration of the CE), so as to make it form interconnection and intercommunication with the directly connected CE. At the same time, issuing the configurations related to the corresponding VPN1 to the PE1 and the PE3 through the configuring component includes:

1. enabling VRF: enabling the VRF instance, and configuring the RD and RT attributes (setting an import value and an export value) (in this block, the RD and RT configurations are optional; when import and export of routing entries are intensively controlled by the I2RS Client entirely, there is no need to perform this block; when it is needed to be compatible with the existing router, there is a need to perform this block; this block relates to import and export configurations of the VRF route; when the import and export are intensively controlled by the Client entirely, the Client is required to issue a value of the VPN ID; when there are different VPN needing to communicate with each other, the different RT IDs are carried for sending; the different VPN know through the policy that they can communicate with each other);

2. binding of the VRF interface;

3. configuration of a VRF access routing protocol;

4. enabling of related VPN under the BGP: adding a VRF address family, establishing a VPN neighbour, and importing and exporting the VRF route through the BGP VPN neighbour (this block is optional, when import and export are intensively controlled by the I2RS Client entirely, there is no need to perform this block; when it is needed to be compatible with the existing router, there is a need to perform this block; performing of this block relates to distribution of the private network label; when the VPN neighbour is established successfully, the private network label is distributed for the route of the local CE side; when the import and export are intensively controlled entirely, then the Client issues the private label of each route);

5. opening of a public network route and a label link.

The related configurations of the interface, the route and the label protocol for the VPN implementation are performed on the CE and the P device simultaneously.

Similarly, after the customer of the VPN2 makes requirements through application, the configurations of the VPN1 are issued to the corresponding devices.

When each PE obtains the related configurations of the VPN, it generates a Table ID corresponding to the VRF route locally for storing the routes informed locally or remotely of the VPN customer.

Because the NMS has the requirement from an upper application for directly rewriting routing entry information under the related VPN Table ID, the mapping relation between the VPN ID and the Table ID needs to be fed back to the Client through the PE. The Client can learn table item maintenance ID of different VRF on each PE, and directly reads and writes the table item contents with the same RT value. The table item contents cover the key value of table item, the outgoing interface, the VPN ID, the routing protocol type, the priority and the metric shown in the following Table. Specifically, as shown in FIG. 6, there are three customer terminals whose IP are respectively IP1, IP2 and IP3 accessing the site 1; there are only two terminals whose IP are respectively IP5 and IP6 accessing the site 3, then the table items of CE1 side route learned by the PE1 are:

TABLE 1

| Key value of | Outgoing | Routing | | |
|---|---|---|---|---|
| table item | interface | protocol type | Priority | Metric |
| IP1 | IF1 | EBGP | 100 | 10 |
| IP2 | IF1 | EBGP | 100 | 10 |
| IP3 | IF1 | EBGP | 100 | 10 |

The key value of table item appears as a customer route of the local CE side, which is used for identifying the IP of the destination address of the customer to which the remote data message is sent; the outgoing interface represents an interface for direct connection between the PE1 and the CE1; the Table ID of the table item stored on the PE1 is 2; the VRF routing protocol of accessing is EBGP; both the import value and the export value of the RT set by the VPN are 100:1; then the PE1 sends the information that the Table ID is 2 and both the import value and the export value of the RT are 100:1 and the specific entries of the table item to the Client through the local Agent component.

Similarly, the table items of CE3 side route learned by the PE3 are:

TABLE 2

| Key value of | Outgoing | Routing | | |
|---|---|---|---|---|
| table item | interface | protocol type | Priority | Metric |
| IP5 | IF1 | OSPF | 110 | 10 |
| IP6 | IF1 | OSPF | 110 | 10 |

The key value of table item appears as a customer route of the local CE side; the outgoing interface represents an interface for direct connection between the PE3 and the CE3; the Table ID of the table item stored on the PE3 is 3; the VRF routing protocol of accessing is OSPF; both the import value and the export value of the RT set by the VPN are 100:1; then the PE13 sends the information that the Table ID is 3 and both the import value and the export value of the RT are 100:1 and the specific entries of the table item to the Client through the local Agent component.

The NMS summarizes through the Client all the routes in the VPN1 and adds the VPN forwarding plane IDs for them; the outgoing interface is replaced with the unique ID of the PE that the route accesses and the best is using the address of loopback of the PE:

TABLE 3

| | | Key | | | | | VPN |
|---|---|---|---|---|---|---|---|
| | | value | | | | | for- |
| | | of | | | | | warding |
| Table | RT | table | Outgoing | Routing | | | plane |
| ID | value | item | interface | protocol | Priority | Metric | ID |
| 2 | import: | IP1 | PE1 | EBGP | 100 | 10 | 17 |
| | 100:1 | | | | | | |
| | export: | | | | | | |
| | 100:1 | | | | | | |
| 2 | import: | IP2 | PE1 | EBGP | 100 | 10 | 18 |
| | 100:1 | | | | | | |
| | export: | | | | | | |
| | 100:1 | | | | | | |
| 2 | import: | IP3 | PE1 | EBGP | 100 | 10 | 19 |
| | 100:1 | | | | | | |
| | export: | | | | | | |
| | 100:1 | | | | | | |
| 3 | import: | IP5 | PE3 | OSPF | 110 | 10 | 100 |
| | 100:1 | | | | | | |
| | export: | | | | | | |
| | 100:1 | | | | | | |
| 3 | import: | IP6 | PE3 | OSPF | 110 | 10 | 101 |
| | 100:1 | | | | | | |
| | export: | | | | | | |
| | 100:1 | | | | | | |

After summarizing, the NMS informs each PE of the customer routing information of the remote PE and informed part of the table item contents through the Client; if the Client informs that the routing protocol type is implemented through the way of BGP, then it appears as an IBGP, and the priority is modified correspondingly; the routing protocol type here may also be I2RS type, and the corresponding priority may be 10; a smaller value of the priority is better. At the same time, the outgoing interface may be either the router-id of the remote PE connected locally or a tunnel which is specified by the Client to the remote PE after searching, wherein the tunnel indicates that it is able to directly reach an opposite end PE through the tunnel; the tunnel may be identified by a specified Tunnel ID. According to the same RT value, the Client writes the learned route of the PE3 into the table item whose Table ID is 2 of the PE1:

TABLE 4

| | | | | | VPN |
|---|---|---|---|---|---|
| Key value of | Outgoing | Routing | | | forwarding |
| table item | interface | protocol type | Priority | Metric | plane ID |
| IP5 | PE3 | IBGP | 200 | 10 | 100 |
| IP6 | PE3 | IBGP | 200 | 10 | 101 |

Similarly, the related table item contents will also be issued to the Table 3 of the PE3, and the specific contents are issued by making the local two routes carry the labels distributed to them by the Client; the routing entries from the remote PE1 are:

TABLE 5

| | | | | | VPN |
|---|---|---|---|---|---|
| Key value of | Outgoing | Routing | | | forwarding |
| table item | interface | protocol type | Priority | Metric | plane ID |
| IP1 | Tunnel | I2RS | 10 | 10 | 17 |
| | 100 | | | | |
| IP2 | Tunnel | I2RS | 10 | 10 | 18 |
| | 100 | | | | |
| IP3 | Tunnel | I2RS | 10 | 10 | 19 |
| | 100 | | | | |

Tunnel 100 here represents that the Client learns after searching that it is able to directly reach the PE1 from the PE3 through the Tunnel 100; the Tunnel may be either the tunnel of a gre or the tunnel of a lsp te; certainly, it may also be a lsp.

Under the situation of centralized configuration and uniform management of the table items, because the routing information of each PE may be issued through the I2RS Client, there is no need to synchronize information through the BGP between the PEs; the local information is intensively fed back to the Client, and then the Client selects to issue the routes belonging to the same VPN customer to the corresponding PE according to the RT attribute, so as to reduce protocol message processing on the PE. Because the table item may be directly read and written by the Client, when there are special application requests, such as flow filtering of an Access Control List (ACL), time period requirement, special scenario deployment, e.g. double-returning, the Client modifies the related entries according to the user requirements and network instability situation, and addition and deletion or the specified next hop rewriting are directly performed without need of forming complex configuration on the PE, so the related policy configuration of the VPN is implemented.

### Embodiment 3

### The Customer Presents Policy Application Processing with Flow Filtering and Time Period Requirements Based on the Embodiment 1

As shown in FIG. 6, based on the description of the embodiment 1, the embodiment explains the situation that the customer requests a VPN service opening application with the flow filtering request. For example, the customer of the VPN1 requires that some of the Clients which belong to different sites may direct access each other, and the other sites which belong to different sites cannot access each other; For example, there are three customer terminals, whose IPs are respectively IP1, IP2 and IP3, accessing the site 1; there are only two terminals, whose IPs are respectively IP5 and IP6, accessing the site 3. It is required that the IP1 and the IP2 may communicate with the IP5, and the IP3 and the IP6 can only communicate with members in the same site, then according to the flow filtering request, related VPN entries are issued through the Client; the IP1 and the IP2 in the site 1 issue the entries to the PE3 so as to enable the PE3 learn address prefixes of the IP1 and the IP2 from the remote PE1 in the same VPN; the IP5 in the site 3 issues the entries to the PE1 to enable the PE1 to learn only the prefix of the IP 5 from the remote PE3. Compared with the prior art, the function may be implemented without need of configuring related ACL entries on each PE and calling the policy by a BGP process.

On the basis of collecting by the Client in the above embodiment, the table items which may be formed according to the application are:

TABLE 6

| | | Key | | | | | VPN |
|---|---|---|---|---|---|---|---|
| | | value | | | | | for- |
| Ta- | | of | | Routing | | | warding |
| ble | RT | table | Outgoing | protocol | | | plane |
| ID | value | item | interface | interface | Priority | Metric | ID |
| 2 | import: | IP1 | PE1 | EBGP | 100 | 10 | 17 |
| | 100:1 | | | | | | |
| | export: | | | | | | |
| | 100:1 | | | | | | |
| 2 | import: | IP2 | PE1 | EBGP | 100 | 10 | 18 |
| | 100:1 | | | | | | |
| | export: | | | | | | |
| | 100:1 | | | | | | |
| 2 | import: | IP3 | PE1 | EBGP | 100 | 10 | 19 |
| | 100:1 | | | | | | |
| | export: | | | | | | |
| | 100:1 | | | | | | |
| 3 | import: | IP5 | PE3 | OSPF | 110 | 10 | 100 |
| | 100:1 | | | | | | |
| | export: | | | | | | |
| | 100:1 | | | | | | |
| 3 | import: | IP6 | PE3 | OSPF | 110 | 10 | 101 |
| | 100:1 | | | | | | |
| | export: | | | | | | |
| | 100:1 | | | | | | |

It can be seen that the IP3 and the IP6 cannot send out the inform, and the issued table item entries of a remote customer of the corresponding PE1 only include the IP5 as follows:

TABLE 7

| | | | | | VPN |
|---|---|---|---|---|---|
| Key value of | Outgoing | Routing | | | forwarding |
| table item | interface | protocol type | Priority | Metric | plane ID |
| IP5 | PE3 | IBGP | 200 | 10 | 100 |

The table item entries of the remote customer which are issued to the corresponding PE3 only include the IP1 and the IP2:

TABLE 8

| | | | | | VPN |
|---|---|---|---|---|---|
| Key value of | Outgoing | Routing | | | forwarding |
| table item | interface | protocol type | Priority | Metric | plane ID |
| IP1 | PE1 | I2RS | 10 | 10 | 17 |
| IP2 | PE1 | I2RS | 10 | 10 | 18 |

When the flow filtering takes effect only at working time of the morning or the afternoon, an upper client may issue the corresponding entries and delete the entries in time according to the timer on the Client; the time parameters may be carried in the table item or the corresponding configuration to be issued. For example, the flow filtering request described in the first paragraph of the embodiment 2 contains the time requirement, that is, some of the customers may access across the sites only in working hours, and are not allowed to access each other except the normal working hours. Thus, to implement the policy of effective time period, the Client may issue the entry information of a corresponding reachable remote end to the local in the working hours, and may also carry an effective timestamp ID in the table item; or the policy of effective time period may be implemented by configuring and carrying an effective time ID. Compared with organization of the table item contents, addition and deletion of the table item entries as shown in the Table are involved here; a part of the contents may be selected to implement time contents in the table item.

TABLE 9

| Key | | | | | | |
|---|---|---|---|---|---|---|
| value | Out- | | | | VPN | |
| of | going | Routing | | | for- | |
| table | inter- | protocol | Prior- | | warding | |
| item | face | type | ity | Metric | plane ID | Effective time |
| IP5 | PE3 | IBGP | 200 | 10 | 100 | 8:00 am-18:00 pm |

TABLE 10

| Key | | | | | | |
|---|---|---|---|---|---|---|
| value | | | | | | |
| of | | Routing | | | VPN | |
| table | Outgoing | protocol | | | forwarding | Effective |
| item | interface | type | Priority | Metric | plane ID | time |
| IP1 | PE1 | I2RS | 10 | 10 | 17 | 1000 s |
| IP2 | PE1 | I2RS | 10 | 10 | 18 | 1000 s |
| IP3 | PE1 | I2RS | 10 | 10 | 19 | 1000 s |

### Embodiment 4

### On the Basis of the Embodiment 1, the Customer Makes a Double-Returning Access Request to Implement a Protection Function of the L3VPN

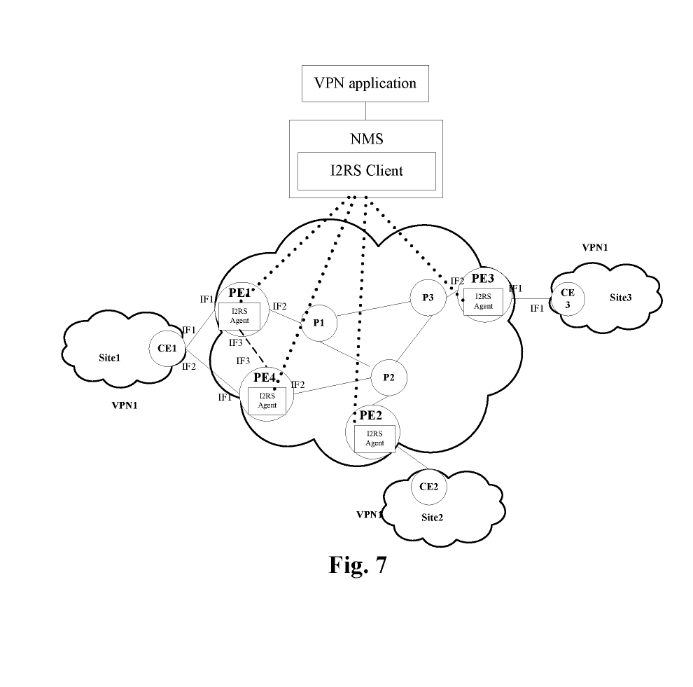

As shown in FIG. 7, on the basis of description of the embodiment 1, because there are many terminals under the site 1 of the VPN1 customer, and the services under the site 1 are quite important, a VPN service opening application with the double-returning request is needed. The application issues the corresponding application to the NMS; then the NMS provides two neighbouring PE to the site 1 for accessing according to network topologies; the corresponding configurations are issued by the configuring component; and the specific table item management is performed by the I2RS Client.

TABLE 11

| | | | | | | | Private | | |
|---|---|---|---|---|---|---|---|---|---|
| | | Destination | | Routing | | | network | Master/ | |
| Table | RT | address | | protocol | | | label | slave | Load |
| ID | value | prefix | Next hop | type | Priority | Metric | value | ID | sharing ID |
| Table | import | 32-bit IP | IP or | ISIS/ | Priority | Metric | Label | Master/ | Optimal |
| ID | RT/ | address & | outgoing | OSPF/ | | | | slave | effective |
| | export | mask | interface | BGP | | | | ID | ID |
| | RT | | | | | | | | |

As shown in FIG. 11, because there are many terminals under the site 1, and the services under the site 1 are busy and have higher priority, then the two neighbouring PE, namely the PE1 and the PE4, are provided to the site 1 to provide double-returning access so as to form protection on the two PE. When a protection function is expected, an application for protection from the upper layer is requested after sensing the whole network topology, the Clients issues a Fast-Reroute (FRR) table item to both the PE1 and the PE4 which indicates that there is a next hop of a suboptimal route to a PE node forming a double-returning binding relation, that is, a route whose next hop to a remote site is PE4 is issued to the PE1; compared with the existing optimal route, by carrying the master/slave ID in the table items to be issued, the two table items are issued simultaneously; after a main route is ineffective, there is no need to recalculate the path. The specific table items on the PE1 are shown in Table 12:

TABLE 12

| Destination | Next | Routing | | | Master/ |
|---|---|---|---|---|---|
| address prefix | hop | Protocol type | Priority | Metric | slave ID |
| PE3 | IF2 | OSPF | 110 | 10 | Master ID |
| | | | | | setting |
| PE3 | IF3 | OSPF | 110 | 20 | Slave ID setting |

The destination address prefix here represents the loopback address that the opposite PE creates the MPBGP, which is used for searching a public network label.

The optimal next hop reaches the CE3 connected with the remote PE3 through the IF2 directly connected with the P1; at this point, it is needed to issue a suboptimal route which reaches the CE3 connected with the remote PE3 and whose next hop is the PE4 to the PE1; the route whose next hop is the P1 is marked with the master ID, and the route whose next hop is the PE4 is marked with the slave ID. When it is sensed that the optimal route is ineffective, the flow forwarded by the PE1 may reach the CE3 through the suboptimal route whose next hop is the PE4.

Correspondingly, under the scenario, when it is required that the remote sites in the same site have VPN FRR protection, then returning flow PE3 may be returned through the PE1 and the PE4. Because of the original default mode of implementation, for example, when the CE1 accesses the PE1 and the PE4 in a double-returning way, and the same VPNV4 routing information transferred from the PE1 and the PE4 is learned by the PE3, the route priorities are compared correspondingly, and only the optimal route is selected to issue the forwarding table, which cannot guarantee the FRR for returning the flow. When the retuned flow exceeds link bandwidth of the optimal route or the optimal route is ineffective, the PE3 senses that the route is ineffective and calculates a new route, thus packet loss cannot be avoided.

Under the situation, to implement the application for protection of the returning flow, the Client needs to simultaneously issue two publishers PE1 and PE4, which publish the routes to the CE1 with the same prefix of the IP1, to the PE3; both the routes published by the two publishers are written into the table item of route; a VPN FRR function is enabled to make the returning flow fast switch through a way of protection; at last, when the forwarding table is issued, it will be used for searching the different public network labels according to the two next hops; when the link to the PE1 is interrupted or the node of the PE1 is ineffective, it is feasible to switch to the link of the PE4 in time to transmit the flow, so as to guarantee the timely accessibility of the flow. For the table item contents, the implementation mainly adds the master/slave ID to basic information.

TABLE 13

| | | | | | Private | |
|---|---|---|---|---|---|---|
| Destination | | Routing | | | network | Master/ |
| address | Next | Protocol | | | label | slave |
| prefix | hop | type | Priority | Metric | value | ID |
| IP1 | PE1 | IBGP | 200 | 10 | 17 | Master ID |
| | | | | | | setting |
| IP1 | PE4 | IBGP | 200 | 10 | 18 | Slave ID |
| | | | | | | setting |

### Embodiment 5

### On the Basis of the Embodiment 1, the Customer Makes the Double-Returning Access Request and Requires Implementing a VPN Load Sharing Function

As shown in FIG. 7, on the basis of description of the embodiment 1, because there are many terminals under the site 1 of the VPN1 customer, and the services under the site 1 are quite important, the VPN service opening application with the double-returning request is needed. The application issues the corresponding application to the NMS; then the NMS provides two neighbouring PE to the site 1 for accessing according to network topologies; the corresponding configurations are issued by the configuring component; and the specific table item management is performed by the I2RS Client.

As shown in Table 11, because there are many terminals under the site 1, and the services under the site 1 are busy and have higher priority, then the two neighbouring PE, namely the PE1 and the PE4, are provided to the site 1 to provide double-returning access; the remote PE3 site may reach the CE1 simultaneously through the PE1 and the PE4. Therefore, when the PE3 has a VPN load sharing application, the PE3 may forward the flow to the CE1 simultaneously through the PE1 and the PE4. Because of the original default mode of implementation, for example, when the CE1 accesses the PE1 and the PE4 in the double-returning way, and the same VPNV4 routing information transferred from the PE1 and the PE4 is learned by the PE3, the route priorities are compared correspondingly, and only the optimal route is selected to issue the forwarding table, which cannot guarantee the load sharing of the returning flow, and when the retuned flow exceeds link bandwidth of the optimal route or the optimal route is ineffective, the PE3 senses the route is ineffective and calculates a new route, so that packet loss cannot be avoided.

Under the situation, to implement the load sharing application of the returning flow, the Client needs to simultaneously issue two publishers PE1 and PE4, which publish the routes to the CE1 with the same prefix of the IP1, to the PE3; both the routes published by the two publishers are written into the table item of route; a load sharing function is enabled; at last, when the forwarding table is issued, it will be used for searching the different public network labels according to the two next hops, so as to enable the returning flow to reach the CE1 through two links; in this way, when the flow exceeding a single link bandwidth is transmitted, the packet loss is avoided. For the table item contents, the implementation mainly adds the load sharing ID to the basic information.

TABLE 14

| Destination | | Routing | | | Private | |
|---|---|---|---|---|---|---|
| address | Next | Protocol | | | network | Load |
| prefix | hop | type | Priority | Metric | label value | sharing ID |
| IP1 | PE1 | IBGP | 200 | 10 | 17 | Setting |
| IP1 | PE4 | IBGP | 200 | 10 | 18 | Setting |

### Embodiment 6

### Automatic Control and Related Table Item Issuing for the L2VPN

Compared with the description of implementation of the L3VPN in the embodiment 1, the implementation of the L2VPN is different in that:

the customer has no need to sense configurations of a provider network, but directly accesses through the layer 2. The existing L2VPN configurations mainly include:

1. configuration of a direct-connection interface or a remote session interface between the PE1 and the PE2;

2. configuration of the routing protocol;

3. configuration of the LDP;

4. configuration of an L2VPN instance; note that, the neighbour of VPN transmission Pseudo-Wire (PW) should be consistent with the LDP neighbour. The configuration mainly includes binding of an Access Circuit (AC) interface and the configuration of the PW neighbour.

Because the configuration of the existing L2VPN instance is configuration needing to specify the PW neighbour on the PE which intercommunicate with each other in the whole network, and the configuration is required to be compatible with the LDP neighbour or the BGP neighbour; the work load of configuration is quite large and a subtle configuration is required; under the situation of manual configuration error, the customers of the same VPN may not intercommunicate with each other.

In the framework of the I2RS, as shown in FIG. 6, the customer makes the requirements according to the application layers provided in the I2RS model; for example, the customer of the VPN1 makes, through the application layer, the requirement to the NMS of opening intercommunication between the site 1 and the site 3 through the VPN; the NMS knows the PE connected to the site 1 and the site 3 are the PE1 and the PE3 through the topology collection, then the NMS returns the interface configuration information related to the PE1 and the PE3 to the customer. At the same time, issuing the corresponding VPN1 related configurations to the PE1 and the PE3 through the configuring component includes: the binding of the AC interface, wherein because the distribution of inner labels involved in the establishment of the PW may be issued by the Client uniformly, the original establishment of the PW neighbour is not needed any more in the existing environment; the configuration of the intermediate transmission route and the label protocol, wherein if an intermediate node P is controlled by the Client, then the outer labels may be issued uniformly.

After obtaining the VPN related configurations, each PE locally generates the Table ID of a corresponding VPN MAC for storing the MAC, which is informed locally or remotely, of the VPN customer.

Because the I2RS Client has the requirement for directly rewriting MAC entry information under the related Table ID, the mapping relation between the VPN ID and the Table ID needs to be fed back to the Client through the PE. The Client may learn the table item maintenance IDs of different VPNs on each PE, and directly reads and writes the table item contents with the same VPN ID. The table item contents include the destination MAC address, the opposite PE ID, the private network label, the public network ID, the local outgoing interface, and so on shown in the following Table. As shown in FIG. 6, there are three customer terminals, whose MAC are respectively MAC1, MAC2 and MAC3, accessing the site 1; there are only two terminals, whose MAC are respectively MACS and MAC6, accessing the site 3, then the MAC table items of the CE1 learned by the PE1 are:

TABLE 15

| Destination | | | | Local outgoing |
|---|---|---|---|---|
| address | Peer PE | inner label | outer label | interface |
| MAC1 | LOCAL | Null | Null | IF1 |
| MAC2 | LOCAL | Null | Null | IF1 |
| MAC3 | LOCAL | Null | Null | IF1 |

Similarly, such a table is also on the PE3; when the VPN ID and the table item ID carried by the table item are summarized to the Client, and the Client distributes the public network label and the private network label for them, then the summarized VPN table items are:

TABLE 16

| Destination | | | outer | Source | Table |
|---|---|---|---|---|---|
| address | Peer PE | inner label | label | PE | ID |
| MAC1 | PE1, PE3 | 17 | 99 | PE1 | 2 |
| MAC2 | PE1, PE3 | 18 | 99 | PE1 | 2 |
| MAC3 | PE1, PE3 | 19 | 99 | PE1 | 2 |
| MAC5 | PE1, PE3 | 201 | 66 | PE3 | 3 |
| MAC6 | PE1, PE3 | 202 | 66 | PE3 | 3 |

When the Client issues the customer information to the PE1, wherein the customer information is from the PE3 which is in the same VPN with the PE1, then the following table item information is written in the Table2 of the PE1:

TABLE 17

| Destination | | | outer | Local outgoing |
|---|---|---|---|---|
| address | Peer PE | inner label | label | interface |
| MAC5 | PE3 | 201 | 66 | IF2 |
| MAC6 | PE3 | 202 | 66 | IF2 |

When there is an I2RS model which may be different from that provided by the present disclosure, if they are configuration issuing and table item issuing or obtaining performed on a routing system through the interfaces of external devices (which may include a server or an X-Router) according to the I2RS protocol, then the present disclosure can also cover the I2RS model which is different from the I2RS provided by the present disclosure.

### Embodiment 7

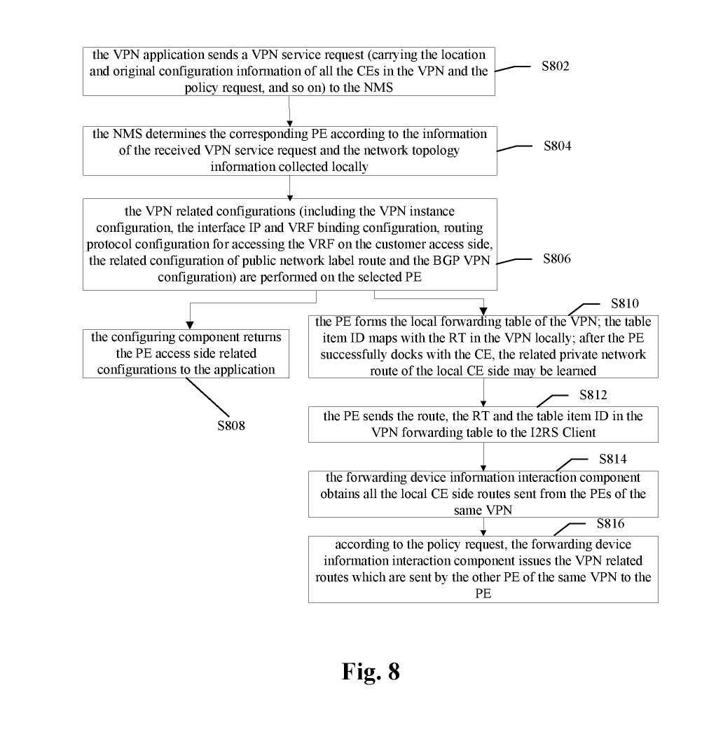

FIG. 8 is a flowchart of a method for implementing automatic control of a VPN according to a preferred embodiment of the present disclosure. As shown in FIG. 8, the method includes the following blocks.

In block 802, the VPN application sends a VPN service request (carrying the location and original configuration information of all the CEs in the VPN and the policy request, and so on) to the NMS.

In block 804, the NMS determines the corresponding PE according to the information of the received VPN service request and the network topology information collected locally.

In block 806: the VPN related configurations (including the VPN instance configuration, the interface IP and VRF binding configuration, routing protocol configuration for accessing the VRF on the customer access side, the related configuration of public network label route and the BGP VPN configuration) are performed on the selected PE; here, two flows are generated; one is directly turning to block 808, and then ending; the other is turning to block 810, and continuing.

In block 808, the configuring component returns the PE access side related configurations to the application.

In block 810, the PE forms the local forwarding table of the VPN; the table item ID maps with the RT in the VPN locally; after the PE successfully docks with the CE, the related private network route of the local CE side may be learned.

In block 812, the PE sends the route, the RT and the table item ID in the VPN forwarding table to the I2RS Client.

In block 814, the forwarding device information interaction component obtains all the local CE side routes sent from the PEs of the same VPN.

In block 816, according to the policy request, the forwarding device information interaction component issues the VPN related routes which are sent by the other PE of the same VPN to the PE.

It can be seen from the above embodiments that the present disclosure achieves the following beneficial effects: topology information resources that the I2RS Client can obtain is compared with the related implementation of manual configuration, an automation effect may be provided more conveniently, and a policy control request may be implemented more timely; also, the configurations needed by each PE device are simplified, and a function of issuing and writing the customer information into the table may be provided.

Obviously, the skilled personnel in the field should appreciate that the above components and blocks of the present disclosure can be implemented by a general-purpose computing device, and they can be centralized in a single computing device or distributed on a network composed of multiple computing devices; optionally, they can be implemented by a program code which is capable of being executed by the computing device, so that they can be stored in a storage device and executed by the computing device; in addition, under some conditions, the presented or described blocks can be executed in an order different from that described here; or they are made into integrated circuit components, respectively; or multiple components and blocks of them are made into a single integrated circuit component to realize. In this way, the present disclosure is not limited to any particular combination of hardware and software.

The above is only the preferred embodiment of the present disclosure and not intended to limit the present disclosure; for the skilled personnel in the field, the present disclosure may have various modifications and changes. Any modifications, equivalent replacements, improvements and the like within the spirit and principle of the present disclosure shall fall within the scope of the claims of the present disclosure.

### INDUSTRIAL APPLICABILITY

The above technical solutions provided by the present disclosure can be applied to the process of VPN implementation processing of the edge device; by adopting the technical means of performing centralized calculation and processing on the VPN application request and the VPN routing information of the edge device to issue the obtained configuration and routing control information, the technical problems in the prior art that there are more complex configuration and table item contents in an automatic control solution for the VPN, etc. are solved, thereby being able to automatically control simpler configuration issuing, more intensive table item management and table item issuing under a uniform control platform, so that the configuration and table item capacity of the existing device are reduced.

What is claimed is:

1. A Virtual Private Network (VPN) implementation processing method for an edge device, comprising:
acquiring a VPN application request, wherein the VPN application request carries attribute configuration information about a VPN;
receiving VPN routing information from each edge device in the VPN; and
sending VPN routing control information to the each edge device, wherein the VPN routing control information is routing information obtained by performing centralized calculation and processing on the attribute configuration information and the VPN routing information.

2. The method according to claim 1, wherein the VPN routing information or the routing control information comprises at least one piece of the following:
a VPN Table Identity (ID) and table item entries, wherein the VPN Table ID is used for locally identifying a table item number generated according to the VPN routing information.

3. The method according to claim 2, wherein the table item entries comprise at least one of the following:
a key value of table item, a next hop, an outgoing interface, a protocol type, a VPN ID, a VPN forwarding plane ID, a master/slave ID, a load sharing ID and effective time.

4. The method according to claim 2, wherein the table item entries in the VPN routing information and the table item entries in the routing control information are partly same or totally different.

5. The method according to claim 3, wherein the key value of table item comprises: a destination address of a data message.

6. The method according to claim 3, wherein the next hop is a direct next hop ID of the edge device or a peer ID of a multi-hop neighbour.

7. The method according to claim 3, wherein the outgoing interface from the edge device to a Network Management System (NMS) is a local VPN binding interface or a local device ID of the edge device, and the outgoing interface from the NMS sends to the edge device is a mapping ID of a remote edge device.

8. The method according to claim 7, wherein the mapping ID comprises at least one of the following:
the ID of the remote edge device;
a logical outgoing interface ID or a physical outgoing interface ID of the edge device to the remote edge device.

9. The method according to claim 3, wherein the protocol type is used for identifying a Routing System (I2RS) protocol and/or other routing protocols except the I2RS protocol.

10. The method according to claim 3, wherein the VPN forwarding plane ID is used for identifying an encapsulated or de-encapsulated data plane message.

11. The method according to claim 3, wherein the master/slave ID is used for respectively identifying multiple next hops with the same key value of table item as master and slave.

12. The method according to claim 3, wherein the VPN ID is in one-to-one correspondence with the VPN on a control plane.

13. The method according to claim 3, wherein the load sharing ID is used for identifying the multiple next hops with the same key value of table item.

14. The method according to claim 3, wherein the effective time is realized by at least one of the following ways:
taking effect and timing according to time to live which is configured by the edge device or defaulted;
synchronously taking effect on the edge device according to an effective time period which is issued by the NMS;
sending or cancelling sending the routing information in the NMS according to local effective time.

15. The method according to claim 1, wherein the attribute configuration information comprises at least one piece of the following: a VPN ID, information about setting of a Routing Target (RT) value, information about ID of a Provider Edge (PE) site requiring opening the VPN, information about a type of a routing protocol needing to be enabled, priority configuration information and policy information.

16. The method according to claim 15, wherein the policy information comprises at least one piece of the following:
a filtering or changing policy based on table item entry contents, a time presetting policy, a master/slave policy and a load sharing policy.

17. The method according to any one of claims 1 to 16, wherein the edge devices comprise at least one of the following: a PE and a Customer Edge (CE).

18. A Virtual Private Network (VPN) implementation processing method for an edge device, characterized by comprising:
sending VPN routing information to a Network Management System (NMS);
receiving VPN routing control information from the NMS, wherein the VPN routing control information is VPN routing information obtained by performing centralized calculation and processing on the VPN routing information and attribute configuration information about a VPN which is obtained by the NMS from a VPN application request;
configuring the edge device according to the VPN routing control information.

19. The method according to claim 18, wherein the VPN routing information or the routing control information comprises at least one piece of the following:
a VPN Table Identity (ID) and table item entries, wherein the VPN Table ID is used for locally identifying a table item number generated according to the VPN routing information.

20. The method according to claim 19, wherein the table item entries comprise at least one of the following:
a key value of table item, a next hop, an outgoing interface, a protocol type, a VPN ID, a VPN forwarding plane ID, a master/slave ID, a load sharing ID and effective time;
wherein, the key value of table item comprises: a destination address of a data message; and/or the next hop is a direct next hop ID of the edge device or a peer ID of a multi-hop neighbour; and/or the outgoing interface from the edge device to the NMS is a local VPN binding interface or a local device ID of the edge device and the outgoing interface from the NMS sends to the edge device is a mapping ID of a remote edge device; and/or the protocol type is used for identifying a Routing System (I2RS) protocol and/or other routing protocols except the I2RS protocol; and/or the VPN forwarding plane ID is used for identifying a encapsulated or de-encapsulated data plane message; and/or the master/slave ID is used for respectively identifying multiple next hops with the same key value of table item as master and slave; and/or the VPN ID is in one-to-one correspondence with the VPN on a control plane; and/or the load sharing ID is used for identifying the multiple next hops with the same key value of table item.

21. The method according to claim 19, wherein the table item entries in the VPN routing information and the table item entries in the routing control information are partly same or totally different.

22. The method according to claim 20, wherein the mapping ID comprises at least one of the following:
an ID of the remote edge device;
a logical outgoing interface ID or a physical outgoing interface ID of the edge device to the remote edge device.

23. The method according to claim 20, wherein the effective time is realized by at least one of the following ways:
taking effect and timing according to time to live which is configured by the edge device or defaulted;
synchronously taking effect in the edge device according to an effective time period which is issued by the NMS;
sending or cancelling sending the routing information in the NMS according to local effective time.

24. The method according to claim 18, wherein the attribute configuration information comprises at least one of the following: the VPN ID, information about setting of a Routing Target (RT) value, information about an ID of a Provider Edge (PE) site requiring opening the VPN, information about a type of the routing protocol needing to be enabled, priority configuration information and policy information.

25. The method according to claim 24, wherein the policy information comprises at least one piece of the following:
a filtering or changing policy based on table item entry contents, a time presetting policy, a master/slave policy and a load sharing policy.

26. A Virtual Private Network (VPN) implementation processing device for an edge device, comprising:
an acquiring component configured to acquire a VPN application request, wherein the VPN application request carries attribute configuration information about a VPN;
a receiving component configured to receive VPN routing information from each edge device in the VPN; and
a sending component configured to send VPN routing control information to the edge devices, wherein the VPN routing control information is routing information obtained by performing centralized calculation and processing on the attribute configuration information and the VPN routing information.

27. The device according to claim 26, wherein the receiving component and the sending component are respectively configured to receive the VPN routing information and send the VPN routing control information when the VPN routing information and/or the VPN routing control information comprise/comprises at least one piece of the following:
a VPN Table Identity (ID) and table item entries, wherein the VPN Table ID is used for locally identifying a table item number generated according to the VPN routing information.

28. The device according to claim 27, wherein the receiving component and the sending component are respectively configured to receive the VPN routing information and send the VPN routing control information when the table item entries comprise at least one of the following:
a key value of table item, a next hop, an outgoing interface, a protocol type, a VPN ID, a VPN forwarding plane ID, a master/slave ID, a load sharing ID and effective time;
wherein the key value of table item comprises: a destination address of a data message; and/or the next hop is a direct next hop ID of the edge device or a peer ID of a multi-hop neighbour; and/or the outgoing interface from the edge device sends to a Network Management System (NMS) is a local VPN binding interface or a local device ID of the edge device and the outgoing interface from the NMS sends to the edge device is a mapping ID of a remote edge device; and/or the protocol type is used for identifying a Routing System (I2RS) protocol and/or other routing protocols except the I2RS protocol; and/or the VPN forwarding plane ID is used for identifying a encapsulated or de-encapsulated data plane message; and/or the master/slave ID is used for respectively identifying multiple next hops with the same key value of table item as master and slave; and/or the VPN ID is in one-to-one correspondence with the VPN on a control plane; and/or the load sharing ID is used for identifying the multiple next hops with the same key value of table item.

29. A Virtual Private Network (VPN) implementation processing device for an edge device, comprising:
a sending component configured to send VPN routing information to a Network Management System (NMS);
a receiving component configured to receive VPN routing control information from the NMS, wherein the VPN routing control information is routing information obtained by performing centralized calculation and processing on the VPN routing information and attribute configuration information about a VPN which is obtained by the NMS from a VPN application request; and
a configuring component configured to configure the edge device according to the VPN routing control information.

30. The device according to claim 29, wherein the receiving component and the sending component are respectively configured to receive the VPN routing control information and send the VPN routing information when the VPN routing control information and/or the VPN routing information comprise/comprises one of the following:
a VPN Table Identity (ID) and table item entries, wherein the VPN Table ID is used for locally identifying a table item number generated according to the VPN routing information.

31. The device according to claim 30, wherein the receiving component and the sending component are respectively configured to receive the VPN routing control information and send the VPN routing information when the table item entries comprise at least one of the following:
a key value of table item, a next hop, an outgoing interface, a protocol type, a VPN ID, a VPN forwarding plane ID, a master/slave ID, a load sharing ID and effective time;
wherein the key value of table item comprises: a destination address of a data message; and/or the next hop is a direct next hop ID of the edge device or a peer ID of a multi-hop neighbour; and/or the outgoing interface from the edge device sends to the NMS is a local VPN binding interface or a local device ID of the edge device and the outgoing interface from the NMS to the edge device is a mapping ID of a remote edge device; and/or the protocol type is used for identifying a Routing System (I2RS) protocol and/or other routing protocols except the I2RS protocol; and/or the VPN forwarding plane ID is used for identifying a encapsulated or de-encapsulated data plane message after; and/or the master/slave ID is used for respectively identifying multiple next hops with the same key value of table item as master and slave; and/or the VPN ID is in one-to-one correspondence with the VPN on a control plane; and/or the load sharing ID is used for identifying the multiple next hops with the same key value of table item.
